(19) United States
(12) Patent Application Publication
(10) Pub. No.: US 2024/0392137 A1
(43) Pub. Date: Nov. 28, 2024

(54) SOL-GEL COATING FORMULATIONS AND METHODS TO MITIGATE GALVANIC CORROSION

(71) Applicant: LUNA LABS USA, LLC., Charlottesville, VA (US)

(72) Inventors: Adam GOFF, Charlottesville, VA (US); Rebecca MARTIN, Charlottesville, VA (US); Bryan KOENE, Charlottesville, VA (US); Benjamin PINKSTON, Charlottesville, VA (US)

(21) Appl. No.: 18/694,181

(22) PCT Filed: Dec. 20, 2022
(86) PCT No.: PCT/US22/53466

§ 371 Date: Mar. 21, 2024

Related U.S. Application Data
(60) Provisional application No. 63/292,563, filed on Dec. 22, 2021.

(51) Int. Cl. C09D 5/08; C09D 7/41; C09D 7/61; C09D 7/65; C09D 183/06; C09D 183/16

(52) U.S. Cl. CPC C09D 5/08; C09D 7/41; C09D 7/61; C09D 7/65; C09D 183/06; C09D 183/16

(57) ABSTRACT

Durable, pigmented and transparent, inorganic-organic hybrid sol, gel coating materials are provided which mitigate galvanic corrosion of metal substrates. The coating materials are generally an acid catalyzed condensation reaction product comprised of an organic polymeric silane (e.g., a polyol functionalized with a silane through a urethane linkage or a polyamine functionalized with a silane through a urea linkage, such as isocyanatopropyltrimethoxysilane or isocyanatopropyltriethoxysilane), an inorganic metal alkoxide (e.g., silicon alkoxides such as tetraethoxysilane or tetramethoxysilane) and metal oxide nano particles such as silica (SiCte) which may optionally include other additives such as color agents and/or corrosion inhibitors.

### CROSS-REFERENCE TO RELATED APPLICATION

This application is based on and claims priority benefits from U.S. Provisional Application Ser. No. 63/292,563 filed on Dec. 22, 2021 (Atty. Dkt. 8760-0009), the entire contents of which are expressly incorporated hereinto by reference.

### GOVERNMENT RIGHTS

The disclosed embodiments were made with support by the Office of Naval Research, Contracts #N00014-14-P-1231 and #N68335-16-C-0121.

### FIELD

Sol-gel coatings optionally containing corrosion inhibitors that mitigate galvanic corrosion on metal substrates by providing an excellent physical and electrical barrier, and enhanced passivation in corrosive environments are disclosed. When the coating is applied to either the cathode (e.g. steel fastener, rivet, bushing, etc.) or the anode (e.g. aluminum aircraft skin, automotive body, etc.), the coating acts to reduce the available cathodic current density in a galvanic couple. This reduction in current translates into reduced corrosive attack of the anode.

### BACKGROUND

Load bearing structures utilize fasteners for mechanical attachment and gripping applications. Examples range from aircraft, bridges, buildings, automobiles, and numerous other structures all over the world. Most applications require corrosion mitigation solutions integrated across the structure to enhance survivability and service life. One primary example includes aircraft since they necessitate advanced corrosion solutions in order to maintain structural integrity and utilization readiness. In particular, cathodic fasteners located adjacent to anodic aluminum alloys can lead to significant galvanic corrosion of the aluminum. Cathodic fastener materials may include, but not limited to, corrosion resistant steel (CRES), titanium, copper-beryllium and nickel-based alloys, or other metals, mated to aluminum structures composed of alloys 7075-T6, 2024-T3, 7050-T7451, magnesium alloys, or carbon fiber reinforced polymer (CFRP) composites. Some fastener locations can be especially susceptible to corrosion as sea water and other chloride-containing electrolytes collect in these areas, resulting in a severe occluded environment and aggressive attack. One aspect of the coating embodiments disclosed herein is to provide a novel form of galvanic corrosion protection mechanism to limit attack of aluminum structures and numerous other non-aircraft structures that are prone to galvanic attack.

To protect against corrosion on aircraft, aluminum alloys are routinely chromate conversion coated, primed with chromated epoxy, and top-coated with polyurethane. Similarly, fasteners may be coated with sacrificial metals (Cd, Zn—Ni, IVD Al), pretreated with conversion coatings, and wet installed with sealants or primers. However, metallic coatings can become worn during repeated handling and fastener installation, and defects in the primer/paint system are inevitable during operations. A conventional corrosion resistant adhesive sol-gel is also disclosed in U.S. Pat. No. 10,508,205 (the entire content of which is expressly incorporated hereinto by reference).

Other potential galvanic corrosion applications are embodied by the present invention. Examples are numerous and can include applications where cathodic materials are fastened or connected to anodic metallic materials. Other possible examples include, but not limited to: Magnesium alloys (anode) in contact or containing fasteners that are cathodic (e.g. stainless steel, low alloy steel, nickel and titanium alloys, etc.); Alloy steels with cathodic components attached (e.g. stainless steel fasteners, nickel and titanium alloys, etc.); and Stainless steel alloys with mated cathodic materials like nickel or titanium alloys. Applications are not limited to all-metallic applications because there are numerous examples where carbon or graphite, which is highly cathodic, might be placed in contact with a metallic material. In this situation the carbon or graphite will drive corrosion of the metallic material when an electrolyte is present. The present invention can find application as a protective coating when applied between such mated couples, which are numerous and understood by those having ordinary skill in the art.

The galvanic corrosion between two dissimilar materials is controlled by the available cathodic current. The cathodic current activates the anode surface, causing breakdown of the passive film, initiation of localized corrosion and a decrease in local potential. To combat this phenomenon, there is a need for an easy to apply coating technology that effectively reduces the cathodic driving force (i.e. current) of galvanic corrosion at the dissimilar material interface.

### SUMMARY

The embodiments disclosed herein provide a durable sol-gel coating solution for this problem that is designed to reduce galvanic corrosion by i) providing excellent physical barrier protection against moisture and corrosive ions, and ii) imparting a durable and dense electrically insulating layer between mated components. This sol-gel coating is ideally chrome-free and non-hazardous associated with a water/alcohol based chemistry that results in a highly cross-linked film with excellent corrosion resistance, flexibility, and toughness. The coating systems of the embodiments disclosed herein moreover are capable of drop-in manufacturing application to galvanic materials and structural components via common coating application methods.

The coatings can be applied to any component included in an electrochemical galvanic couple to limit galvanic corrosion attack of the anodic material. One significant example is application to fasteners and bushings that are used on aluminum aircraft structures. In this case, the coating is applied to the target fastener or bushing component (the cathode) and allowed to cure. Then, the coated components are installed into the aluminum aircraft structure per normal methods. The coating will limit the current exchange between the mated interface thereby limiting the galvanic attack of the anode. The reverse is also true in that the coating may be applied to the anode (e.g. aluminum structure) and cured prior to mating of the cathode materials. This concept can be extended to numerous other metallic components, not just aircraft structures.

Preferred embodiments of the coating formulation to inhibit galvanic corrosion will include a galvanic corrosion inhibiting amount of acid catalyzable condensation reactants comprised of (i) an organic polymeric silane; and (ii) an inorganic metal alkoxide. The organic polymeric silane and the inorganic metal alkoxide may be present in a weight ratio of the organic polymeric silane to the inorganic metal alkoxide of between about 1:9 to about 9:1, e.g., about 3:1.

The organic polymeric silane may be a silane functionalized polyol or polyamine. For example, certain embodiments will include a functionalized polycaprolactone polyol having 2 to 4 hydroxyl groups reacted with an isocyanate-terminated silane. The functionalized polycaprolactone polyol may have a molecular weight between 50 and 10,000 g/mol.

The organic polymeric silane may also be a polyurea silane, for example, a polyurea silane which is the reaction product of an amine having at least 2 primary or secondary amine groups with an isocyanate-terminated silane, e.g., a reaction product of diethylenetriamine with an isocyanate-terminated silane.

The metal alkoxide component may include at least one hydrolyzable compound having at least one silane group represented by the formula Si(R¹)ₓ(R²)₄₋ₓ per molecule, wherein R¹ represents a C₁-C₈ alkyl group, an epoxide group, a vinyl group, an acrylic group, R² represents a hydrolyzable alkoxy group or halide group, and x is 0, 1, 2 or 3.

Certain embodiments of the coating formulation described herein will optionally include metal oxide particles with a diameter of 1 nm-100 nm in amounts of 1 to 50 wt. %, based on the total weight of the coating formulation. Preferred metal oxide particles have the formula MₓO_{y}, where M is selected from the group consisting of Si, Ti, Zr, B, Al, Ge, V, Pb, Sn and Zn, and y is an integer. Substantially spherical nanoparticles of alumina, titania, silica and zirconia having an average diameter of 1 to 10 nm are especially preferred.

The coating formulations may additionally include an optional color agent (e.g., an organic color pigment or an organic dye) and/or a corrosion inhibitor (e.g., compounds having one or more thiol moieties, modified and unmodified hydrotalcite compounds, zinc phosphate, zinc oxide, cerium phosphate, cerium nitrate, cerium oxide, aluminum cerium oxide; strontium aluminum polyphosphate and zinc aluminum polyphosphate).

These and other aspects of the present invention will become more clear after careful consideration is given to the following detailed description of a presently preferred exemplary embodiment thereof.

### BRIEF DESCRIPTION OF THE DRAWINGS

Reference will be made to the accompanying drawing Figures, wherein:

FIG. 1 is a photograph showing a representative coated glass coupon having the cured coating formulation of Table 1 below;

FIG. 2 is a photograph showing a representative coated glass coupon having the cured coating formulation of Table 2 below;

FIGS. 3A and 3B are photographs showing a 316 stainless steel flat panel (FIG. 3A) and titanium alloy fasteners (FIG. 3B) each coated with a cured coating formulation of Table 2 below;

FIG. 4 is a graphical presentation of electrochemical polarization sweeps for bare 316 stainless steel compared to 316 stainless steel coated with the cured formulation of Table 2 where testing was performed in 3.5% NaCl at pH 7 and room temperature with a scan rate of 0.2 mV/s to a maximum current density of 10 mA/cm2 starting from open circuit potential;

FIGS. 5A-5D are graphical presentations of electrochemical impedance spectroscopy results for bare 316 stainless steel compared to 316 stainless steel coated with the cured formulation of Table 2 taken after 3.5 hr immersion in 3.5% NaCl where the AC amplitude was 10 mV rms and the frequency range was 10 kHz to 10 mHz with 10 points per decade;

FIGS. 6A-6C are photographs showing the appearance of three coatings prepared with different corrosion inhibitors as applied to glass substrates according to Example 3 below, where FIG. 6A includes 7% of Intelli-Ion® AX1, FIG. 6B includes 10% Novinox® PAS, and FIG. 6C includes 12% cerium nitrate hexahydrate;

FIGS. 7A-7B are photographs showing the results of various bare and coated 316 stainless steel fasteners mated to aluminum alloy 7075-T6 panels before and after 14 days exposure according to ASTM B117 salt fog conditions;

FIG. 8 shows photographic results of various coatings applied to aluminum alloy 7075-T6 panels and scribed to bare substrate, after 14 days exposure according to ASTM B1117 salt fog conditions;

FIGS. 9A and 9B are photographs of bare Ti-6Al-4V and 316 stainless steel fasteners installed into a painted 7075-T6 aluminum alloy panel (FIG. 9A) compared to sol-gel coated fasteners (FIG. 9B) before and after 500 hours of ASTM B1117 salt fog exposure and coating removal which visibly depict significant galvanic corrosion reduction of the 7075-T6 aluminum panel when the hardware was coated with sol-gel coating formulation;

FIGS. 10A and 10B are photographs of 316SS hardware treated with a commercially available corrosion inhibiting product (AC-131) (FIG. 10A) vs. 316SS hardware coated with a sol-gel formulation in accordance with the embodiments herein (FIG. 101B) after 3000 hours of ASTM B1117 salt fog exposure and coating removal which visibly depict significant galvanic corrosion reduction of the 7075-T6 aluminum panel when the hardware was coated with the sol-gel coating formulation; and

FIG. 11 is a graph showing the calculated anodic charge passed which is associated with measured damage down-hole of fasteners shown in FIGS. 10A and 10B after 500 hours of ASTM B1117 salt fog exposure and evidencing the corrosion damage was reduced by >98% using the sol-gel coating formulation as described herein.

### DETAILED DESCRIPTION

Sol-gel derived coatings have been of interest for the passivation of metals including aluminum and steel, due to their ability to form a dense barrier against the penetration of water and corrosion initiators due to their inherent properties including density, low porosity, ease of formulation and non-toxicity. Significant prior work has been performed in the art related to development of these coatings as environmentally benign replacements for the highly-toxic chromate conversion coating. The disclosed embodiments herein build upon this work to produce an exceptionally durable version of such environmentally friendly coating materials.

Inorganic-organic sol-gel coating materials formed from metal alkoxides are well known. In general, sol-gel materials are formed by a mixture of the starting components which react to form a viscous liquid phase as a result of a process of hydrolysis and condensation. The sol-gel processes thus result in an organically modified inorganic material that is harder than conventional organic polymers. In especially preferred embodiments, highly durable coating materials are provided which include an inorganic particulate homogenously distributed throughout an ambiently cured polymeric matrix. When the components of the system are admixed with a suitable catalyst, the coating formulation can be applied onto a substrate surface and allowed to cure thereon to form a highly durable coating.

As noted above the durable, transparent, inorganic-organic hybrid coating for metal substrates according to the embodiments described herein is generally an acid catalyzed condensation reaction product comprised of an organic polymeric silane, an inorganic metal alkoxide and optionally, coloring agents, metal oxide particles and/or corrosion inhibitors. The use of other materials such as alternative catalysts, surfactants, leveling agents, solvents, may be used for their intended purposes as is understood by those having ordinary skill in the art.

### A. Organic Polymeric Silane

The coating material in accordance with the embodiments described herein will necessarily include one or more organosilanes with the general structure RxSi(OR′)y where R is an organic ligand selected from alkyl, epoxide, amine, ether, acrylic, vinyl or polymer/oligomers thereof; x is the number (0-4) of organic substituents; Si is silicon; R′ is a hydrolysable/condensable group selected from hydroxyl, chloro, bromo, methoxy, ethoxy, iso-propoxy, n-propoxy, or iso-butoxy and n-butoxy groups; and y is the number (0-4) of hydrolysable substituents. The organosilane is preferentially a polymeric silane in which the R group is an oligomer or polymer including, but not limited to, epoxy, polyurethane, polyurea, silicone, polyether, polyester, polyamide, acrylates, and the like, with singular or multiple hydrolysable silane groups as described above.

The organic polymeric silane more preferentially includes either a polyol (including but not limited to diols, triols, tetraols, pentols, and the like) or polyamine which is silane functionalized with a metal alkoxide (e.g., an isocyanate terminated silane) through a urethane linkage or a polyamine which is silane functionalized with a metal alkoxide through a urea linkage. The reaction between the polyol and the isocyanate-terminated silane may be catalyzed using an organometal catalyst, such as tin, zinc, bismuth and the like. Other polyols, such as those derived from polyester, polyether, polycarbonate, and the like may also be used.

In preferred embodiments, the polyol or polyamine is silane-functionalized with isocyanatopropyltrimethoxysilane or isocyanatopropyltriethoxysilane through urethane or urea linkages, respectively.

The polyurethane silane can be produced from a wide range of molecular, oligomeric, or polymeric polyether or polyester based polyols possessing at least 2 hydroxyls, preferably 3 or 4 hydroxyls. Polyols with molecular weights between 50 and 10,000 g/mol may be used, preferably 1000-2000 g/mol. For example, CAPA™ brand polyester polyols available commercially from Perstorp Corporation, or ARCOL® brand polyether based polyols commercially available from Bayer Material Science may be used.

Representative polyester and polyether polyols include polycaprolactone diols or triols, polyethyleneoxide diols or triols, polypropylene diols and triols with weight average molecular weights within the ranges noted above may satisfactorily be employed. Preferably, a polycaprolactone triol with the structure:

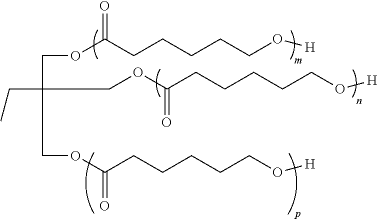

where m+n+p=7-16 may be used.

Polyamines can alternatively be used in the same manner with reaction of the isocyanate-terminated silane through a urea linkage. The polyurea silane can be produced from a wide range of molecular, oligomeric, or polymeric polyamines possessing at least two primary or secondary amine groups, preferably three or four amines per molecule. Polyamines with molecular weights between 50 and 10,000 g/mol may be used, preferably 100-1000 g/mol. For example, diethylenetriamine or JEFFAMINE® amines commercially available from Huntsman Petrochemical Corporation, such as JEFFAMINE® T-403 polyether amine may be employed satisfactorily.

By the term, “polyamine” as used herein, it is meant any aliphatic or aromatic compound containing two or more primary or secondary amine functional groups. The polyamine compound may have any suitable backbone chain structure including saturated or unsaturated, and linear, branched, or cyclic. Representative polyamines include polyetheramines such as diamines with the structure:

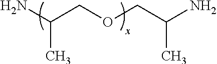

where x=2-70, preferably x is 2-7.

Alternatively the polyetheramine is a triamine with the structure:

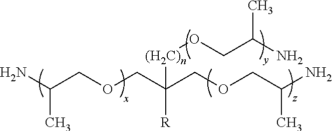

where n=0-5, and x+y+z are 3-100. Preferably n=1 and x+y+z=5-6.

### B. Inorganic Metal Alkoxide

The inorganic metal alkoxide component of the coating material comprises at least one metal alkoxide, such as those based on Si, Ti, Zr, B, Al, Ge, V, Pb, Sn, Zn and the like. Preferred are silicon alkoxides. The silicon alkoxides may also comprise monofunctional organic moieties such as epoxide, alkyl, phenyl, vinyl, mercapto, methacrylate, and the like or be bis-silane terminated, such as bis-trimethoxysilylethane.

The preferred metal alkoxide comprises at least one hydrolyzable compound having at least one silane group, Si(R1)ₓ(R2)4-x, per molecule, wherein R1 represents an alkyl group (for example a C1-C8, polymerizable group (e.g. epoxide, vinyl, acrylic), or other alkyls terminated with another organic moiety (hydroxyl, isocyanate, amino, thiol, etc.), R2 represents a hydrolysable group (for example an alkoxy or halide group, preferably methoxy, ethoxy or chloro) and x is 0, 1, 2, 3. Preferably, the metal alkoxide is tetraethoxysilane or tetramethoxysilane.

### C. Metal Oxide Particles

Metal oxide particles may optionally be used in the coating formulation to impart desired properties, such as abrasion resistance, electrical or optical properties. Such particles should have the form MₓO_{y} with an element M selected from the group consisting of Si, Ti, Zr, B, Al, Ge, V, Pb, Sn and Zn such as silica (SiO₂), alumina (Al₂O₃), titania (TiO₂), and zirconia (ZrO2). Silica (SiO₂) is preferred. For optical transparency, it is preferred that the particles are less than about 100 nm, e.g. between about 1 nm to about 100 nm. The preferred particle size is 1-10 nm diameter spherical nanoparticles. If present, the particles can be included in the coating formulation up to about 50 wt. %, preferably between about 25 wt. % to about 35 wt. %, based on total coating formulation weight.

### D. Color Agents

Color pigments or dyes may optionally be used within the sol-gel formulation to impart a specific color and method of incorporating color into the present disclosure. The invention relates having a coating of 1-25 micron thickness, comprised primarily of polymer or polymer-free coating solids content, containing 1) 0-5% of the weight for colored pigment, and 2) 0-1% for colored dye.

Colored pigments referenced include phthalocyanine-derived metal complexes, indanthrone, perylene quinacridone, diketo-pyrrolo3,4-cpyrrole, dioxazine, diketo-pyrrolo3,4-cpyrrole, 3-amino-1H-isoindol-1-one-oximato-metal complex, are for example, Pigment Blue 15:1, Pigment Blue 15:2, Pigment Blue 15:3, Pigment Blue 15:4, Pigment Blue 15:6, Pigment Blue 16, Pigment Blue 60, Pigment Blue 64 Pigment Green 7, Pigment Green 36, Pigment Green 37, Pigment Red 122, Pigment Red 123, Pigment Red 149, Pigment Red 178, Pigment Red 179, Pigment Red 190, Pigment Red 202, Pigment Red 224, Pigment Red 254, Pigment Red 255, Pigment Red 257, Pigment Red 270, Pigment Red 272, Pigment Violet 19, Pigment Violet 23, Pigment Violet 29 or Pigment Violet 37, diketo-pyrrolo3,4-c-pyrrole, dioxazine, indan throne or perylene pigments. These organic pigments are preferably those with a mean particle diameter (D50) of <1 microns, or are readily dispersible via high-speed dispersion mixing to achieve a pigment mean particle diameter (D50) of <1 micron.

For example, pertaining to organic dispersible pigments, one preferred coating formulation includes 29H,31H-phthalocyanato(2−)-N29,N30,N31,N32) Copper (II), known as copper phthalocyanine blue pigment. Copper phthalocyanine blue exhibits low-reactivity, superior lightfastness, and is completely insoluble in water and most conventional organic solvents. Due to the pigment's insolubility, it must be high-speed dispersed into the formulation. The insoluble character provides the important characteristic to the formulation of minimal to zero leachability into surrounding media, and allows the pigment to be easily bound into the coating framework of the present disclosure. The dispersibility, UV lightfastness, and minimal to absent color leaching collectively provide long-lasting and UV-stable identifying coating color for coatings described herein.

Another example of a coating formulation involves coloration through the incorporation of a soluble or easily dispersible dye, a fine dispersion of a pigment or dye, or a dye in the form of a salt. For example, a preferred formulation contains [4-[4-(diethylamino)-alpha-[4-(ethylamino)-1-napthyl]benzylidene]cyclohexa-2,5-dien-1-ylidene]diethylammonium chloride, known as Victoria Pure Blue BO, or C.I. Basic Blue 7. Other examples of dyes that are preferred are: Keygloss Blue RF, methyl violet 2B, methyl violet 6B, methyl violet 10B, Pararosaniline, Fuchsine, Phenolphthalein, Malachite green, Brilliant blue FCF, Victoria Blue B, Victoria blue FGA, and Victoria blue R. The dye is a high-purity chloride salt of synthetic blue triarylmethane and can be incorporated into either the polymer or catalyst coating solution component. This invention described in the present disclosure includes alcohol soluble, water soluble, or dyes in the form of salts. The use of a chloride salt of a dye offers ease of mixing and identifying blue coating color at low concentrations. Soluble dyes, dye salts, and pigment dispersion solutions can be used at loading levels of about 0.1% to 5.0% by formulation weight. The stated dye can also be of other colors by extension, to those having ordinary skill in the art.

Alternatively, the formulation can be prepared without the presence of colorant additives. These formulations exhibit transparent properties when coated on substrates, and remain optically and visually clear with the addition of selected corrosion inhibitor additives.

### E. Corrosion Inhibitors

Metal aircraft surfaces are typically alloys having a major component, such as aluminum, and one or more minor components for mechanical strengthening, known as an intermetallic. Intermetallics often contain copper metal which can act as small galvanic corrosion spots in that they behave cathodically with the surrounding primary aluminum matrix acting anodically. The cathodic intermetallic phase can accelerate corrosion of the aluminum through galvanic effects when electrolyte (i.e., salt water) is present. The interaction of a wide variety of corrosion inhibitors with aluminum to reduce corrosion have been quantified throughout numerous sources. The unique combination of one or more of these inhibitors in the sol-gel chemistry of the embodiments described herein can provide enhanced protective properties.

Several different types of corrosion inhibitors may be incorporated into the present sol-gel disclosure to enhance the protective properties of the resultant coatings when applied to desired substrates. Inhibitor classes can include one or more of the following: Compounds having one or more thiol moieties with primary examples being benzotriazole and mercaptobenzotriazole; hydrotalcite or hydrotalcite-like compounds with and without additional organic modification; zinc phosphate, zinc oxide, cerium phosphate, cerium nitrate, cerium oxide, aluminum cerium oxide; strontium aluminum polyphosphate; and zinc aluminum polyphosphate.

### F. Composition and Properties

The composition of the coating formulations described herein can vary depending on the desired final properties for corrosion resistance, flexibility, hardness, abrasion resistance, transparency or other desired physical properties. Generally the weight ratio of the polymeric silane to the metal alkoxide or organic functional metal alkoxide in the formulation may be between about 1:9 to about 9:1, preferably about 3:1. The weight percentage of the metal oxide particles in the formulation could be used in a range from about 1 to 50 weight %, preferably between about 10 to about 30 weight %, based on total coating formulation weight. Optional color agents can be used in ranges from about 0.1 to 5.0 weight %, based on total coating formulation weight.

The coating materials may be produced by mixing the inorganic and organic components in a suitable solvent, such as isopropanol, with water and an aqueous acid catalyst. The aqueous acid catalyst is added to initiate the hydrolysis of the hydrolyzable silane groups. Preferred acid catalysts include mineral acid such as hydrochloric acid, sulfuric acid and nitric acid, or an organic acid, such as acetic acid. Sufficient acid catalyst is added to reduce the pH of the reaction mixture to below 5, preferably a pH of between about 2 to about 4. The coating formulation is produced by hydrolysis and condensation of the organic and inorganic silane components, leading to an organic-inorganic network through Si—O—Si bonds.

The obtained coating formulation may be mixed in a solvent, or alternatively without a solvent. If used, the solvent may be an alcohol (methanol, ethanol, propanol, isopropanol, butanol, or the like) or other water miscible solvents, such as acetone. The concentration of the solids in the formulation will depend on the desired thickness for the end application, or application methods. Typically, the formulation will have between about 5 wt. % to about 100 wt. % solids, with a preferred solids concentration being between about 15 wt. % to about 25 wt. %, based on total coating formulation weight.

The liquid coating material may be applied to the substrate using any convenient coating method including dip, brush, flow coat, spray, and the like. The coating material can be cured at a wide range of temperatures depending upon the desired properties, for example abrasion resistance, flexibility, etc., or thermal limitations for the coated substrate. For example, the coating may be cured at temperatures ranging from about 25° C. to about 150° C., preferably about 75° C. The temperature of curing may be modified for compatibility with the substrate.

The thickness of the cured coating may range from about 0.5 micron to about 20 microns, preferably from about 4 microns to about 8 microns.

The coatings described herein are suitable for coating a variety of substrate materials to provide increased corrosion resistance, chemical resistance, water repellency, liquid/gas barrier, abrasion resistance, and watershed capability to the substrate. Suitable substrates include, but are not limited to, glass, metals such as aluminum and steel alloys, plastics such as polycarbonate and acrylic, hardened cement, concrete, or grout, wood and painted surfaces. Additionally, the sol-gel coatings may be overcoated with a wide variety of primers and topcoats, suitable for multiple industries and application such as aerospace, automotive, marine and construction industries to name a few.

The present invention will be further understood by reference to the following non-limiting examples thereof.

### Example 1

A coating material comprising the following formulation was applied as a coating of about 4-8 micron thickness onto a glass substrate (Table 1). The coating was cured at a temperature of about 90° C. The coated substrate was thereafter assessed for visual clarity (Table 1).

### Synthesis of Silane Functional Polyol:

Polycaprolactone polyol is measured into cleaned and thoroughly dried glassware. In a separate cleaned and thoroughly dried piece of glassware, the correct molar ratio of isocyanate silane is measured (e.g. a polycaprolactone diol would require twice the molar amount of isocyanate to caprolactone). The isocyanate glassware is covered with a nitrogen blanket and sealed with a rubber septum. The catalyst (i.e. dibutyltin dilaurate) is measured into the polycaprolactone polyol. For example, one embodiment is to use 0.1% catalyst by weight, relative to the combined measurements of isocyanate and polycaprolactone polyol. The reaction vessel is then also covered with a nitrogen blanket and sealed with a rubber septum.

The polycaprolactone polyol and catalyst are set to stir in an ice bath. The isocyanate is slowly added dropwise into the stirring caprolactone-catalyst mixture, using a positive nitrogen flow to control the addition rate. The ice bath should be maintained during the addition step; the reaction generates heat and the ice bath decreases the chances of side reactions. Once all of the isocyanate is added, the reaction is allowed to come to room temperature as the ice bath melts. The reaction is stirred for at least six hours at ambient temperature. The reduction of the isocyanate peak (˜2270 cm⁻¹) can be measured via Fourier Transform Infrared (FTIR) spectroscopy. Once the isocyanate is fully reacted as evidenced by the loss of the isocyanate stretch in the spectrum, the polyurethane silane should be bottled and covered with nitrogen.

### Standard Coating Synthesis (Ex. 1):

The silanes are mixed first. A molar ratio of 0.4 moles organic silane and 0.6 moles of inorganic silane is typical. Next, the solvent is added to the silane mixture. The solvent volume should be approximately 50-80% of the total coating solution, but can be up to 90% depending on the desired coating thickness. Typical solvents include isopropanol, ethanol, or 1-propanol.

Following full dispersal of the silane into the solvent, acidified water is added. The water should be acidified to a molarity of 0.05-0.1 M, depending on the rate of hydrolysis desired. Hydrochloric acid, acetic acid or nitric acid can be used to decrease the pH of the water solution. The acidified water is added in the molar ratio sufficient to hydrolyze the alkoxy groups on the silanes.

The coating solution will be mixed for 1-2 hours depending on hydrolysis completion. Coating application can be performed using a flow, brush, spray or dip coat method for best results. Once coated, allow excess coating to roll off the substrate before curing. The coating is tack free in approximately 15 minutes at ambient temperature. The coating may alternatively be cured at 75-150° C. for at least 30-60 minutes for increased hardness and toughness.

TABLE 1
Example 1 Coating Formulation Constituents

| Constituents | Loading (grams) |
|---|---|
| 3-Isocyanatopropyl silane | 6.8 |
| Isopropanol | 48.0 |
| Polycaprolactone triol | 4.9 |
| Tetraethoxy silane | 4.4 |
| N Propyl Alcohol/Propanol | 11.5 |
| Colloidal silica nanoparticles | 19.4 |
| 37% Hydrochloric acid | 0.02 |
| Surface Wetting Agent | 0.3 |
| Distilled water | 4.6 |

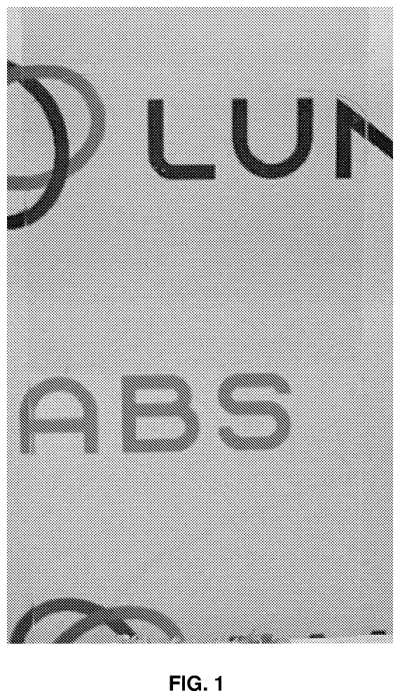

A representative coated glass coupon having the cured coating formulation of Table 1 thereon is shown in FIG. 1.

### Example 2

A coating material comprising the formulation shown in Table 2 was applied as a coating of about 4-8 micron thickness onto glass and metallic substrates. The coating formulation is identical to the coating formulation of Example 1 except that a coloring agent was used. The coating was cured at a temperature of about 90° C.

### Standard Coating Synthesis (Ex. 2):

The silanes are mixed first. A molar ratio of 0.4 moles organic silane and 0.6 moles of inorganic silane is typical. Next, the solvent and pigment are added to the silane mixture. 20-40% of the total solvent quantity is added and fully mixed. The pigment is high speed mixed into the solution to ensure adequate dispersion. Typical solvents include isopropanol, ethanol, or 1-propanol.

Following full dispersal of the silane into the solvent, acidified water is added. The water should be acidified to a molarity of 0.05-0.1 M, depending on the rate of hydrolysis desired. Hydrochloric acid, acetic acid or nitric acid can be used to decrease the pH of the water solution. The acidified water is added in the molar ratio sufficient to hydrolyze the alkoxy groups on the silanes.

The coating solution will be mixed for 1-2 hours depending on hydrolysis completion. Once the silanes are hydrolyzed, the coating is filtered through a 1 m filter prior to coating. Coating application can be performed using a flow, brush, spray or dip coat method for best results. Once coated, allow excess coating to roll off the substrate before curing. The coating is tack free in approximately 15 minutes at ambient temperature. The coating may alternatively be cured at 75-150° C. for at least 30-60 minutes for increased hardness and toughness.

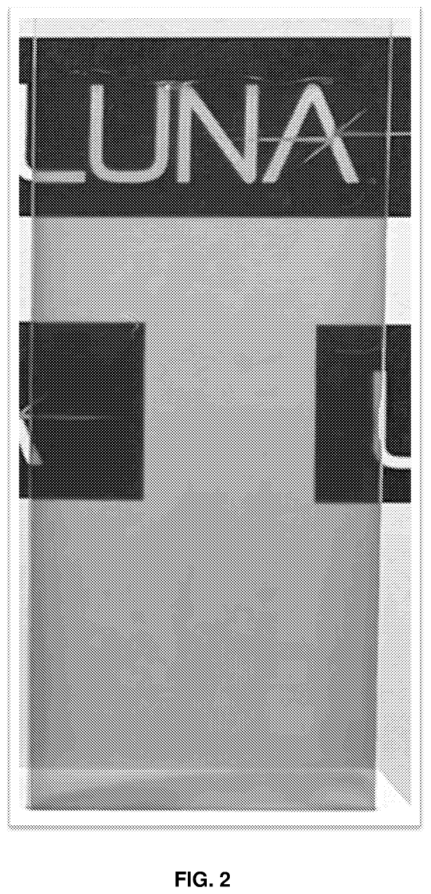

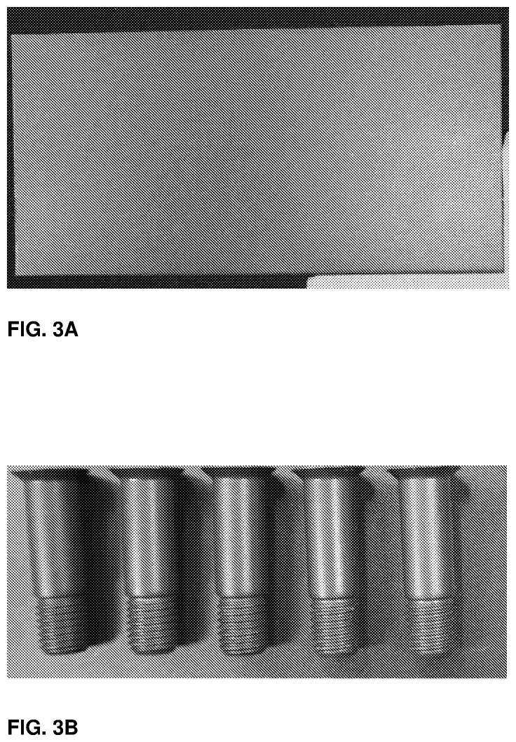

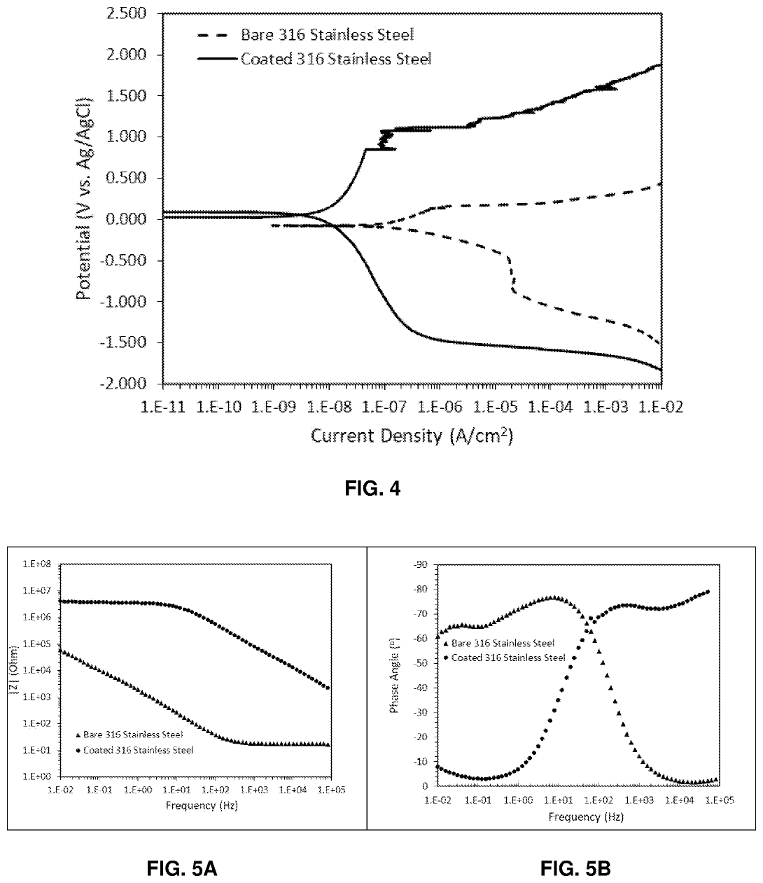

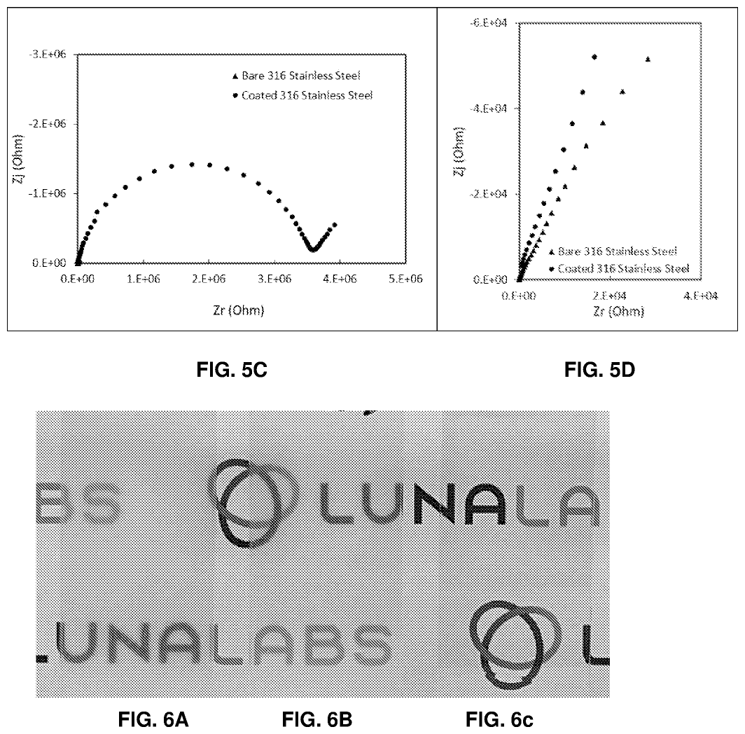

The coated substrate was thereafter assessed for visual clarity as shown in FIG. 2 as well as surface properties as shown in Table 3 and FIGS. 3A and 3B, and electrochemical behavior including electrochemical polarization as shown in FIG. 4 and electrochemical impedance as shown in FIGS. 5A-5D.

TABLE 2
Example 2 Coating Formulation Constituents

| Constituents | Loading (grams) |
|---|---|
| 3-Isocyanatopropyl silane | 6.8 |
| Isopropanol | 48.0 |
| Polycaprolactone triol | 4.9 |
| Tetraethoxy silane | 4.4 |
| N Propyl Alcohol/Propanol | 11.5 |
| Colloidal silica nanoparticles | 19.4 |
| 37% Hydrochloric acid | 0.02 |
| Surface Wetting Agent | 0.3 |
| Distilled water | 4.6 |
| Phthalocyanine Blue 15:4 | 0.3 |

TABLE 3
Property values for contact angle, surface free
energy, optical transparency and optical haze for the
coating example.

| Property (as applied to glass) | Value |
|---|---|
| Water contact Angle (deg) | 80 |
| Surface Free Energy (mN/m) | 30 |
| Optical Transparency (% transmission) | 75 |
| Optical Haze (%) | 1.2 |

### Example 3

Coating materials comprising the following formulation base were applied as a coating of about 4-8 micron thickness onto a glass substrate. The coating formulation is identical to Example 1 except that corrosion inhibitors were incorporated via the same mixing procedure outlined in Example 2 for the color agent. Coatings were prepared with loadings of the following commercial inhibitors in ranges between 5-15 weight % (based on total formulation weight): Novinox® PAS (strontium aluminum polyphosphate), cerium nitrate hexahydrate, and Intelli-Ion® AX1 (benzotriazolate in an ion exchange resin). The coatings were cured at a temperature of 90° C. The coated substrate was thereafter assessed for visual appearance as shown in FIGS. 6A-6C.

### Example 4

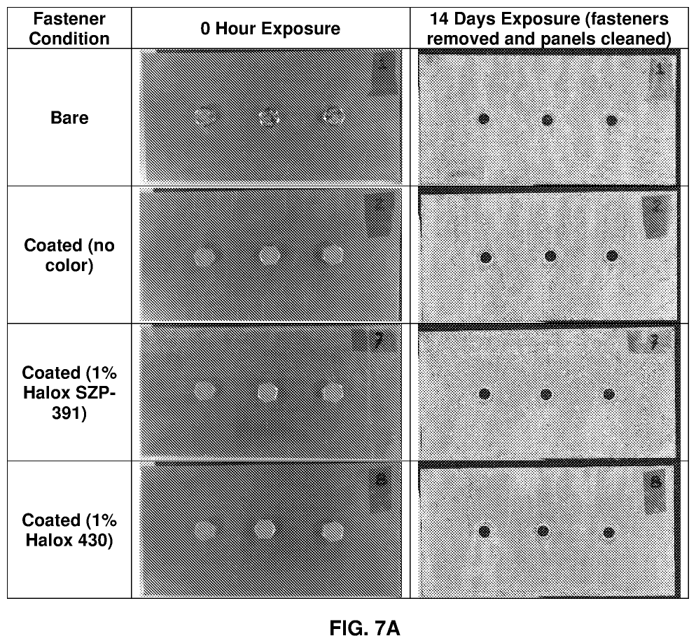

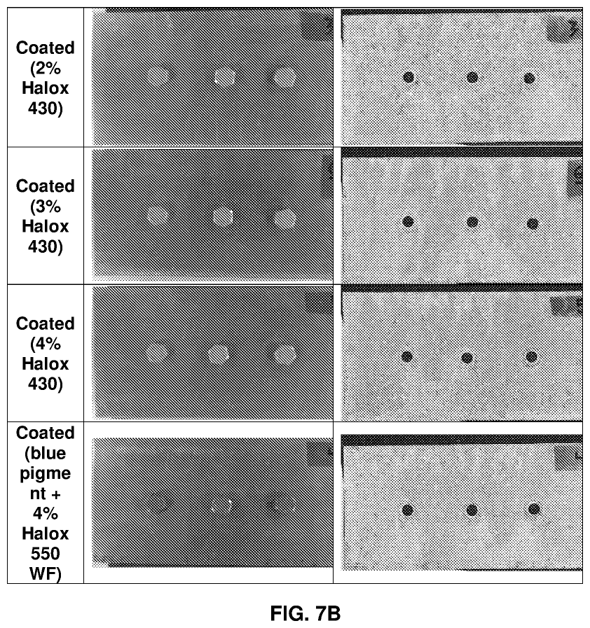

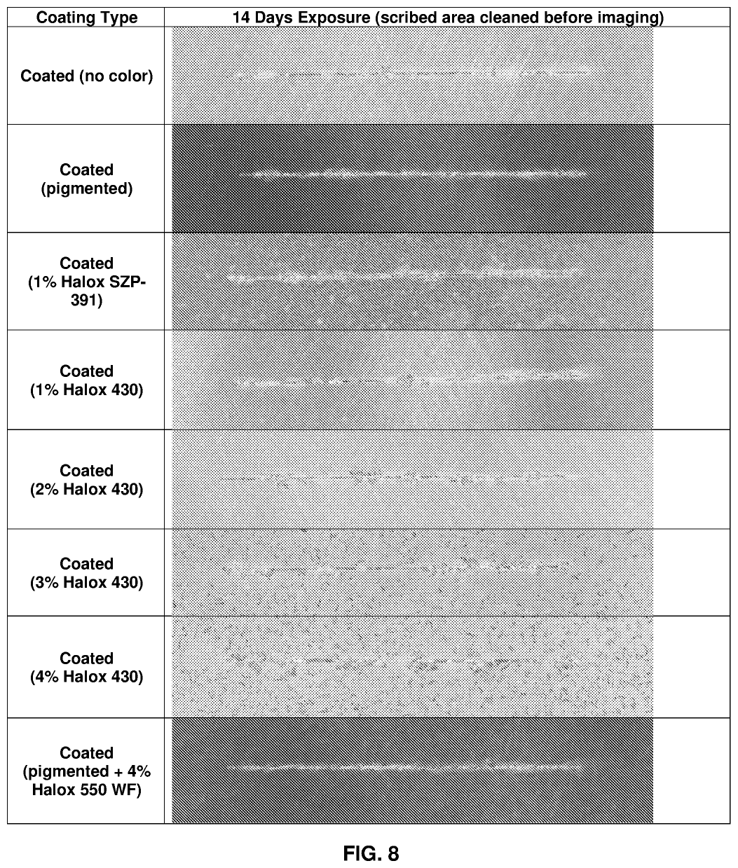

Coatings comprising the following formulation base were applied at about 4-8 micron thickness. The coatings are identical to Example 1 except that corrosion inhibitors were incorporated via the same mixing procedure outlined in Example 2 for the color agent. Coatings were prepared with loadings of the following commercial inhibitors in ranges between 1-5 weight % (based on total coating formulation weight): Halox® 430, Halox® 550 WF and Halox® SZP-391. The coatings were applied to 316 stainless steel fasteners and cured at a temperature of about 90° C. The fasteners were then mated to aluminum alloy 7075-T6 flat panels with matched nuts, and placed into ASTM B117 salt fog testing for 14 days. Exemplary photographic images of coupon results are shown in FIGS. 7A and 7B. Separately, the same coatings were also applied to aluminum alloy 7075-T6 flat panels and scribed through the coating and down to the substrate, prior to undergoing the same 14 day exposure in ASTM B117 salt fog conditions. Exemplary photographic images of coupon results are shown in FIG. 8.

### Example 5

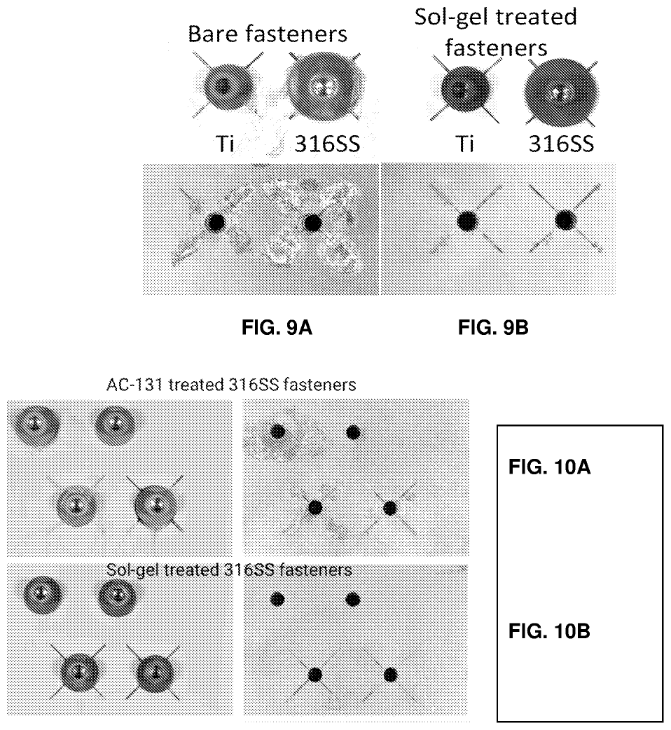

Bare and sol-gel coated Ti-6A1-5V alloy fasteners and 316 stainless steel fasteners were installed into pre-drilled holes of a painted 7075-T6 aluminum alloy panel as shown in the top photographs of FIGS. 9A and 9B, respectively. The sol-gel coated fasteners were cured prior to installation into the holes drilled into the aluminum alloy 7075-T6 panels. After exposure to 500 hours of salt fog conditions according to ASTM B117 and subsequent removal of the coating system from the aluminum panel, the galvanic corrosion protective properties of the coating can be clearly observed as shown by the bottom photograph of FIG. 9B as compared to the poor galvanic corrosion in the case of the uncoated hardware as shown in the bottom photograph of FIG. 9A.

A similar result was obtained when the same sol-gel formulation was applied to 316 stainless steel fasteners as compared to commercial AC-131 from 3M (see FIGS. 10A and 10B). AC-131 is a non-chromate conversion coating for use on aluminum, nickel, stainless steel, magnesium and titanium, and is referenced from U.S. Pat. No. 10,508,205. As can be seen in FIGS. 10A and 10B, galvanic corrosion testing resulted in substantially less damage for the formulated sol-gel herein as compared to the commercially available AC-131 product.

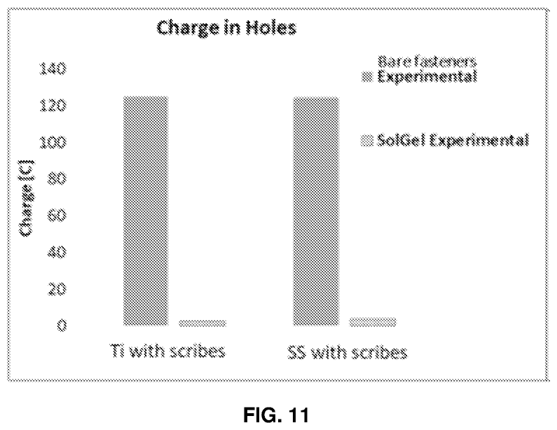

An analysis was completed to quantify the extent of corrosion damage down hole (not surface) for the aluminum panel for bare fasteners as compared to sol-gel coated fasteners as shown in FIGS. 9A and 9B. It was visually obvious from the surface appearance that the plate containing the sol-gel coated fasteners suffered much less corrosion damage than the plate containing the bare fasteners. After analyzing statistical data from cross-sectional metallography, it was seen that all holes with bare fasteners had similar damage metrics, independent of fastener type. The damage down-hole in terms of aluminum volume loss was converted to anodic charge passed using Farady's law for alloys. The results are shown in FIG. 11. From this analysis it was determined that the sol-gel coating formulations of the embodiments described herein reduced the corrosion damage of the aluminum holes by >98% as compared to the bare fastener condition. It is expected, therefore, that the damage protection afforded by the sol-gel coating formulations herein could range from about 25% protection up to full substantially 100% galvanic protection (e.g., from about 75% to about 99%), depending on the environment and test conditions.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope thereof.

What is claimed is:

1. A coating formulation to inhibit galvanic corrosion which comprises a galvanic corrosion inhibiting amount of acid catalyzable condensation reactants comprised of:
(i) an organic polymeric silane; and
(ii) an inorganic metal alkoxide.

2. The coating formulation according to claim 1, wherein the organic polymeric silane and the inorganic metal alkoxide are present in a weight ratio of the organic polymeric silane to the inorganic metal alkoxide of between about 1:9 to about 9:1.

3. The coating formulation according to claim 2, wherein the weight ratio of the organic polymeric silane to the inorganic metal alkoxide is about 3:1.

4. The coating formulation according to claim 1, wherein the organic polymeric silane is a silane functionalized polyol or polyamine.

5. The coating formulation according to claim 1, wherein the organic polymeric silane is a functionalized polycaprolactone polyol having 2 to 4 hydroxyl groups reacted with an isocyanate-terminated silane.

6. The coating formulation according to claim 5, wherein the functionalized polycaprolactone polyol has a molecular weight between 50 and 10,000 g/mol.

7. The coating formulation according to claim 1, wherein the organic polymeric silane is a polyurea silane.

8. The coating formulation according to claim 7, wherein the polyurea silane is a reaction product of an amine having at least 2 primary or secondary amine groups with an isocyanate-terminated silane.

9. The coating formulation according to claim 8, wherein the polyurea silane is a reaction product of diethylenetriamine with an isocyanate-terminated silane.

10. The coating formulation according to claim 9, wherein metal alkoxide comprises at least one hydrolyzable compound having at least one silane group represented by the formula Si(R¹)ₓ(R²)₄₋ₓ per molecule, wherein R¹ represents a C₁-C₈ alkyl group, an epoxide group, a vinyl group, an acrylic group, R² represents a hydrolyzable alkoxy group or halide group, and x is 0, 1, 2 or 3.

11. The coating formulation according to claim 1, which further comprises between about 1 to about 50 wt. %, based on total weight of the coating formulation, of metal oxide particles having a formula MₓO_{y}, wherein M is selected from the group consisting of Si, Ti, Zr, B, Al, Ge, V, Pb, Sn and Zn, and y is an integer.

12. The coating formulation according to claim 4, wherein the metal oxide particles are selected from the group consisting of silica, alumina, titania, and zirconia.

13. The coating formulation according to claim 5, wherein the metal oxide particles are substantially spherical nanoparticles having an average diameter of 1 to 10 nm.

14. The coating formulation according to claim 1, which further comprises 0.1 to 5.0 wt. %, based on total weight of the coating formulation, of a color agent.

15. The coating formulation according to claim 7, wherein the color agent is an organic color pigment or an organic dye.

16. The coating formulation according to claim 1, further comprising a corrosion inhibitor.

17. The coating formulation according to claim 9, wherein the corrosion inhibitor is selected from the group consisting of compounds having one or more thiol moieties, modified and unmodified hydrotalcite compounds, zinc phosphate, zinc oxide, cerium phosphate, cerium nitrate, cerium oxide, aluminum cerium oxide; strontium aluminum polyphosphate and zinc aluminum polyphosphate.

18. A method of inhibiting galvanic corrosion of a metal component which comprises:
(a) applying onto a metal component the coating formulation according to claim 1 in the presence of an acid catalyst; and
(b) allowing the coating formulation to cure on the metal component to thereby inhibit galvanic corrosion when the metal component is subsequently brought into contact with a second metal component.

19. An assembly having inhibited galvanic corrosion comprised of first and second metal components in contact with one another, wherein at least one of the first and second metal components includes a cured coating thereon of an acid catalyzed coating formulation according to claim 1.

20. The assembly according to claim 19, wherein the assembly has reduced galvanic corrosion of about 1% to about 100% as compared to an assembly of the first and second metal components without the cured coating thereon.

21. An assembly comprising:
first and second metal components in contact with one another, wherein
at least one of the first and second metal components includes a cured coating thereon of an acid catalyzed coating formulation according to claim 1, and wherein
the coated assembly further comprises a secondary coating which overcoats the cured coating.

22. A method to impart galvanic protection to a metal assembly comprising first and second metal components in contact with one another comprising:
(a) applying a galvanic protective coating of the coating formulation according to claim 1 onto at least one of the first and second metal components;
(b) joining the first and second metal component in contact with one another to form an assembly thereof;
(c) curing the galvanic protective coating either before or after step (b) to form a cured galvanic protective coating; and
(d) applying a secondary coating over the assembly of the first and second metal components.

23. A coated metal assembly made by the method according to claim 22.
